(19) United States
(12) Patent Application Publication
(10) Pub. No.: US 2007/0218941 A1
(43) Pub. Date: Sep. 20, 2007

(54) Wireless apparatus capable of communicating with GPS and ground-based wireless system

(75) Inventor: Sheng Ming Deng, Hsinchu (TW)

Correspondence Address: OLIFF & BERRIDGE, PLC, P.O. BOX 19928, ALEXANDRIA, VA, 22320, US

(73) Assignees: WAVEFAR TECHNOLOGY CORP., HSINCHU (TW); WAVERAY TECHNOLOGY CORP., HSINCHU COUNTY (TW)

(21) Appl. No.: 11/599,288

(22) Filed: Nov. 15, 2006

(30) Foreign Application Priority Data
Dec. 28, 2005 (TW) 094222814

(51) Int. Cl. H04M 1/00

(52) U.S. Cl. 455/552.1

(57) ABSTRACT

A wireless apparatus capable of communicating with global positioning system (GPS) and ground-based wireless system includes a positioning signal receiving antenna, at least one circuit board, a case and a panel with input keys. The positioning signal receiving antenna is disposed on the circuit board. The circuit board is disposed inside the panel and the case. The fixed position or fed position of the positioning signal receiving antenna is located in the second quadrant region or the fourth quadrant region relative to the center of the panel, i.e., the upper left region or bottom right region facing the character long axis of the display screen.

### BACKGROUND OF THE INVENTION

1. Field of the Invention

The present invention relates to a wireless apparatus capable of communicating with a GPS (global positioning system) and a ground-based wireless system, and more particularly to a wireless mobile apparatus having optimal GPS signal receiving quality during a calling interval.

2. Description of the Related Art

Since GPS technology was released by the U.S. government in 1985, the navigation function thereof has been widely used in the fields such as seafaring/aviation, emergency rescue, engineering construction, geophysics, and military operation rehearsal. Later, the selective availability (SA) effect was eliminated, such that the positioning precision level is decreased from below 100 m to below 20 m. Therefore, the system can be widely used in car navigation devices.

In another aspect, many mobile phone service providers began to be aware that the application of mobile positioning might become a potential service in the commercial market. Thus, in the late 90s, providers started providing the related service of mobile positioning. Moreover, as the application of mobile positioning must depend on extra software/hardware products such as apparatuses utilizing global positioning technology and the location information database, the mobile positioning service has also attracted attention from manufacturers of geographical information systems (GIS), positioning technology and so on.

Along with the wide application of the mobile positioning service and the increase in the requirement of security, the integration of GPS and cellular phone technology is regarded as a major developing trend of mobile apparatuses in the next 3-5 years. In addition, some manufacturers in regions such as the U.S.A., Europe and Japan have vigorously started development and fabrication of such parts, terminal products, system resolutions and so on.

Furthermore, at present, hand-held wireless mobile apparatuses are required to be light, thin, short and small, so the configuration module, devices and antenna disposed therein must conform to the same requirements or even be integrated with more functions. As for a GPS antenna, if a conventional medium resonant antenna is selected, such an antenna is not only too large in size to meet the above requirements, but also has a narrow signal receiving bandwidth, thus being unsuitable to be applied to a hand-held wireless mobile apparatus.

However, in the aforementioned wireless mobile apparatus, the fixing manner of the positioning signal receiving antenna may directly affect the receiving quality for the global positioning signal. Therefore, a receiving antenna structure that is developed by engineering analysis is needed urgently to make the wireless mobile apparatus have optimal receiving quality for the global positioning signal.

### SUMMARY OF THE INVENTION

An objective of the present creation is to provide a wireless apparatus capable of communicating with a GPS and a ground-based wireless system, which can generate optimal signal receiving effect for the global positioning signal of circularly polarized radiation field.

Another objective of the present creation is to provide a global positioning mobile apparatus favorable to the use manner of the user and having preferable signal receiving effect, wherein the positioning signal receiving antenna is disposed in an optimal region according to the accustomed use manner.

To fulfill the above objectives, the present creation provides a wireless apparatus capable of communicating with a GPS and a ground-based wireless system. The apparatus comprises a positioning signal receiving antenna, at least one circuit board, a case and a panel with input keys. The positioning signal receiving antenna is disposed on the circuit board. The fixed position or feeding point of the positioning signal receiving antenna is located in the second quadrant region or the fourth quadrant region relative to the center of the panel, i.e., the upper left region or bottom right region facing the graphic frame of the display screen. Further, the circuit board is disposed in the inner space formed by the panel and the case.

Moreover, the circuit board is disposed in an extension portion connected to the case. The extension portion may rotate or slide relative to the panel, and may extend outward from the main case. When the extension portion is in an extended state, the fixed position or feeding point of the positioning signal receiving antenna is located in the second quadrant region or the fourth quadrant region relative to the center of the panel, i.e., the upper left region or bottom right region facing the graphic frame of the display screen.

### BRIEF DESCRIPTION OF THE DRAWINGS

The invention will be described according to the appended drawings in which:

FIG. 1 is a schematic stereogram of the wireless apparatus capable of communicating with a GPS and a ground-based wireless system according to the present creation;

FIG. 2 is a top view of the circuit board of the present creation;

FIG. 3(a)-3(b) are schematic stereograms of another wireless apparatuses capable of communicating with GPS and ground-based wireless system according to the present creation;

FIG. 4 is a schematic view of the use of the wireless apparatus capable of communicating with GPS and ground-based wireless system according to the present creation;

FIG. 5 is a radiation field pattern of the positioning signal receiving antenna of the present creation in the X-Y plane in FIG. 1;

FIG. 6 is a radiation field pattern of the positioning signal receiving antenna of the present creation in the X-Z plane in FIG. 1;

FIG. 7 is a schematic stereogram of the wireless apparatus capable of communicating with GPS and ground-based wireless system according to the second embodiment of the present creation; and

FIG. 8 is a schematic stereogram of the wireless apparatus capable of communicating with GPS and ground-based wireless system according to the third embodiment of the present creation.

### PREFERRED EMBODIMENT OF THE PRESENT INVENTION

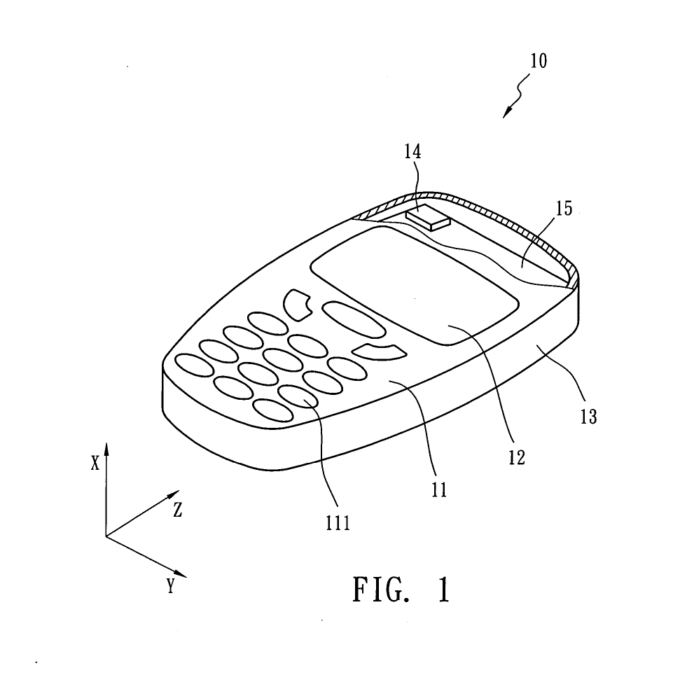

FIG. 1 is a schematic stereogram of the wireless apparatus capable of communicating with GPS and ground-based wireless system according to the present creation. A wireless apparatus 10 integrates the global positioning function into a mobile phone, so besides communicating with the ground-based wireless system (such as GSM, PHS or CDMA), the wireless apparatus 10 can also receive positioning information from satellites and calculate the three-dimensional coordinate values of the current location. The wireless apparatus 10 includes a GPS positioning signal receiving antenna 14, at least one circuit board 15, a case 13, a panel 11 with input keys 111, and a display screen 12 for displaying corresponding messages of the communication. The positioning signal receiving antenna 14 is disposed on the circuit board 15, and the fixed position or feeding position thereof is located in the second quadrant region (upper left) relative to the center of the panel 11.

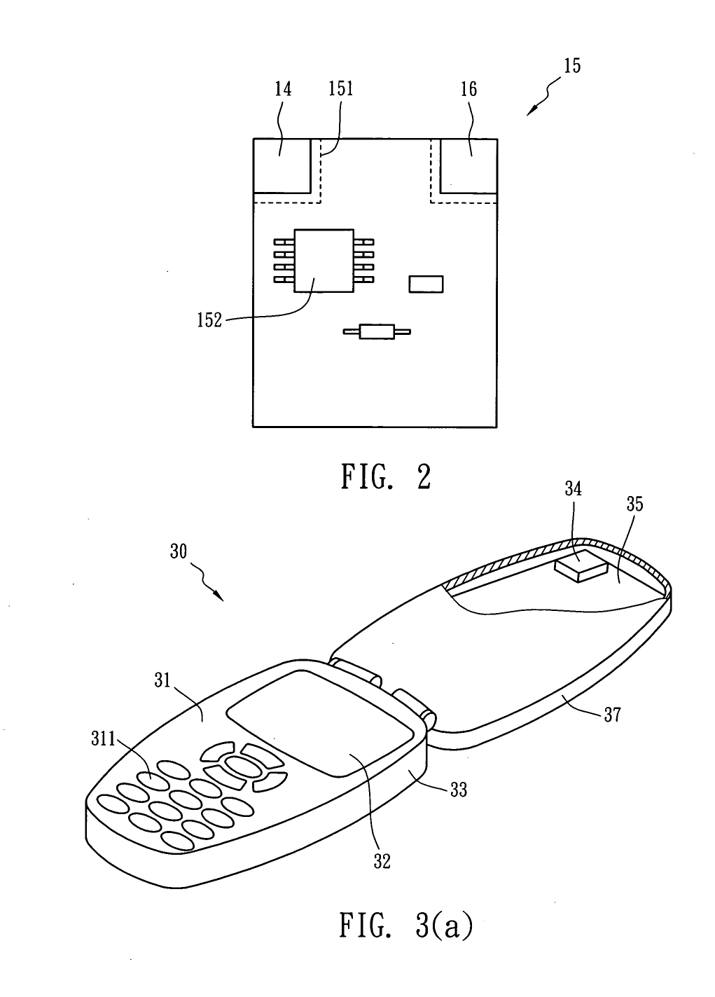

FIG. 2 is a top view of the circuit board of the present creation. The positioning signal receiving antenna 14 is disposed on the upper left of the circuit board 15, thus a preferable signal receiving effect on the positioning signal can be achieved when the user is answering the mobile phone. The positioning signal receiving antenna 14 can be a chip antenna, reversed-L antenna, reversed-F antenna, wire antenna, strip antenna or plane antenna disposed on another circuit board antenna or an antenna obtained by modifying any of the above antennae. A grounded circuit layer 151 inside or at the back of the circuit board 15 cannot overlap the positioning signal receiving antenna 14, i.e., the grounded circuit layer 151 must have a gap or opening with a larger area at the mounting position of the positioning signal receiving antenna 14. Of course, a receiving antenna 16 of the ground-based wireless system can be further disposed at another position on the circuit board 15, and an integrated circuit device 152, such as a digital signal processing device, resistor and capacitor, can also be welded on the circuit board 15 by surface mounting.

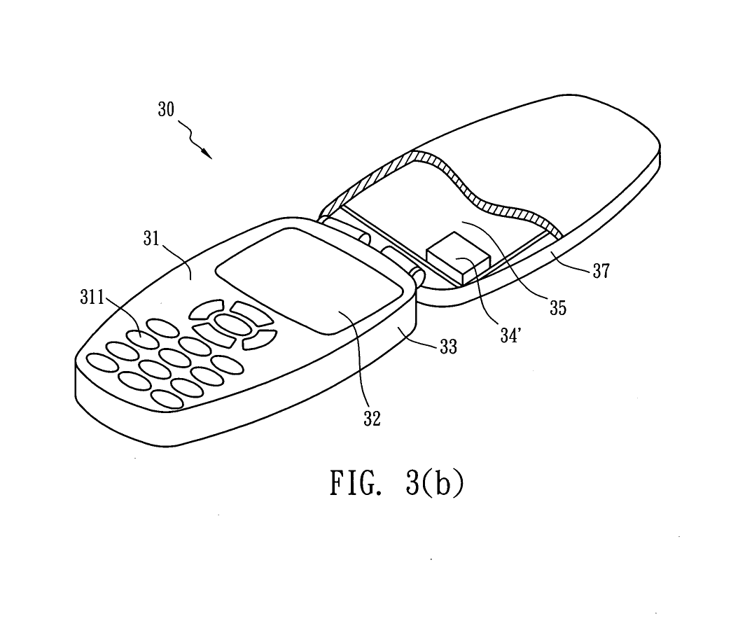

In addition to the coverless wireless apparatus 10 in FIG. 1, there are two types of wireless apparatuses with cover in the market, i.e., rotation cover or slide cover. For example, FIG. 3(a) is a wireless apparatus 30 with a rotation cover. The wireless apparatus 30 includes a GPS positioning signal receiving antenna 34, at least one circuit board 35, a case 33, a panel 31 with input keys 311, and a display screen 32 for displaying related messages of the communication. The circuit board 35 is disposed in an extension portion 37 (cover) pivotally joined to the case 33. The extension portion 37 can rotate relative to the panel (the extension portion may slide horizontally relative to the case in a wireless apparatus with a slide cover). The extension portion 37 can extend outward from the case 33. When the extension portion 37 is in an extended state, the fixed position or feeding position of the positioning signal receiving antenna 34 is still located in the second quadrant region relative to the center of the panel 31. Referring to FIG. 3(b), a GPS positioning signal receiving antenna 34′ is located in the fourth quadrant region relative to the center of the panel 31.

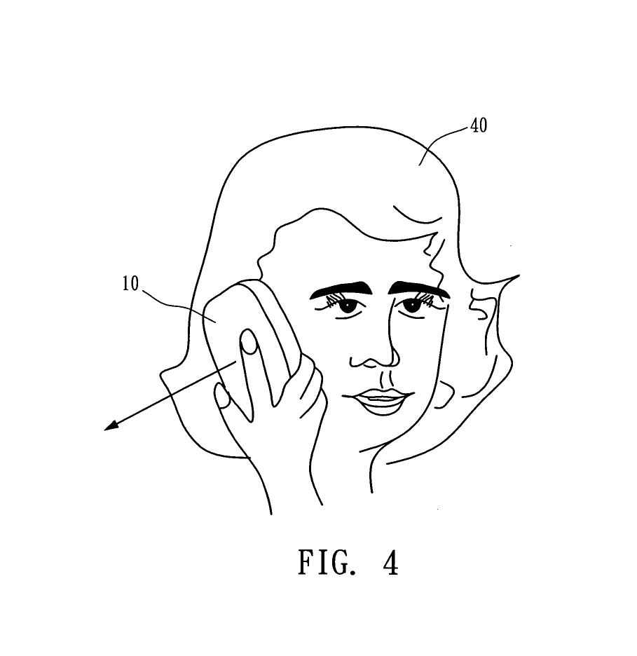

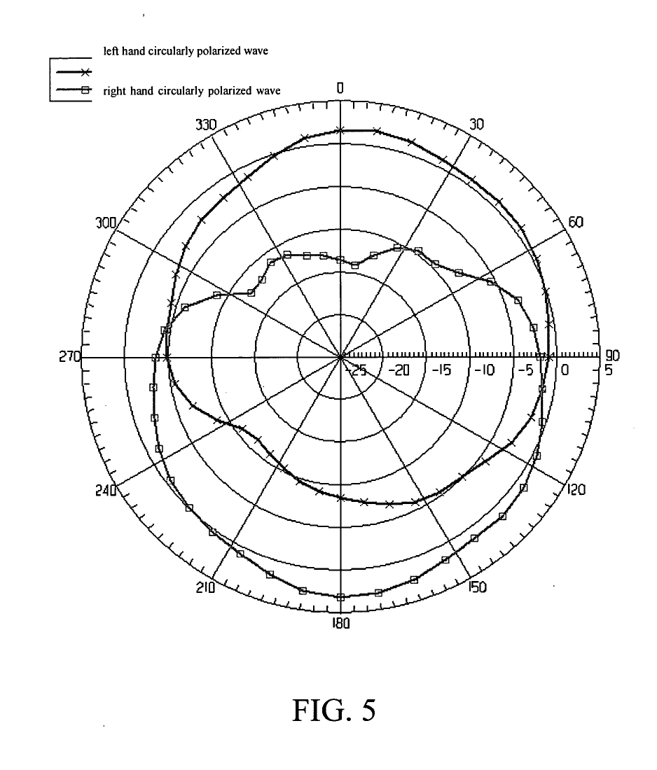

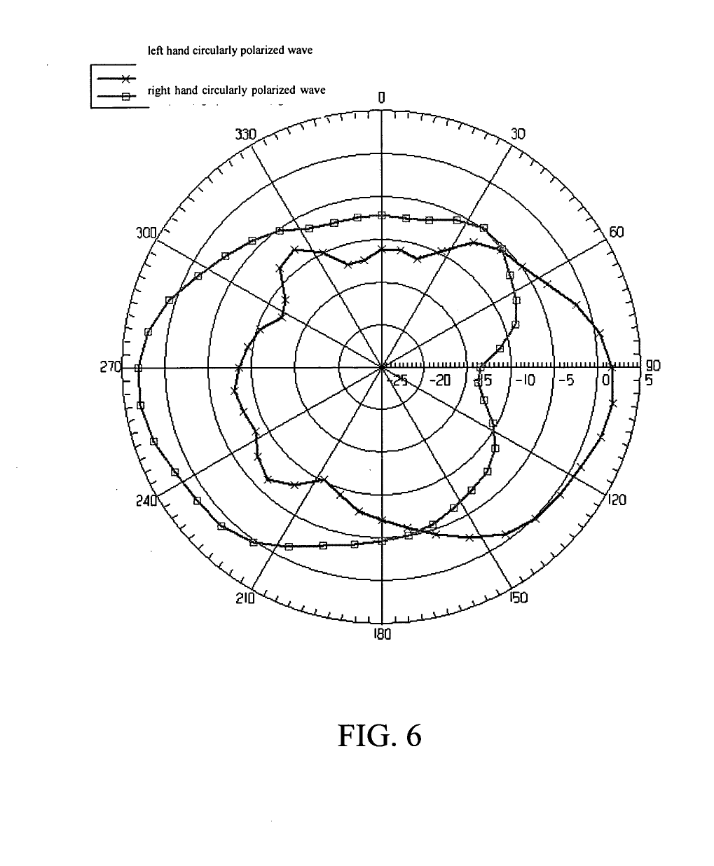

In view of the above, when a user 40 answers the mobile phone with the wireless apparatus 10 of the present creation, the panel 11 is turned inward to the face of the user and the case 13 is turned outward, as shown in FIG. 4. Due to the optimal arrangement of the location of the positioning signal receiving antenna 14, the receiving quality on the right hand circularly polarized global positioning signal along the arrow direction in the figure is the best, i.e., an optimal radiation field pattern can be achieved (referring to FIGS. 5 and 6). Moreover, the positioning signal receiving antenna 14 only receives the right hand circularly polarized global positioning signal, so the global positioning function of the present creation can operate properly without being interfered with by the manner of holding.

FIG. 5 is a radiation field pattern of the positioning signal receiving antenna of the present creation in the X-Y plane in FIG. 1. The left hand circularly polarized wave has the strongest signal at the panel 13 along the positive X axis (in the figure, 0° overlaps the X axis), and oppositely the right hand circularly polarized wave has the strongest signal at the back of the panel 13 along the negative X axis. Therefore, the global positioning function of the personal digital assistant (PDA) apparatus 10 may not be interfered with by the holding manner, that is, a good signal receiving effect may be achieved during the call.

FIG. 6 is a radiation field pattern of the positioning signal receiving antenna of the present creation in the X-Z plane in FIG. 1. Similarly, the left hand circularly polarized wave has the strongest signal at the panel 13 along the positive X axis (in the figure, 0° overlaps the Z axis, and 90° overlaps the X axis), and oppositely the right hand circularly polarized wave has the strongest signal at the back of the panel 13 along the negative X axis.

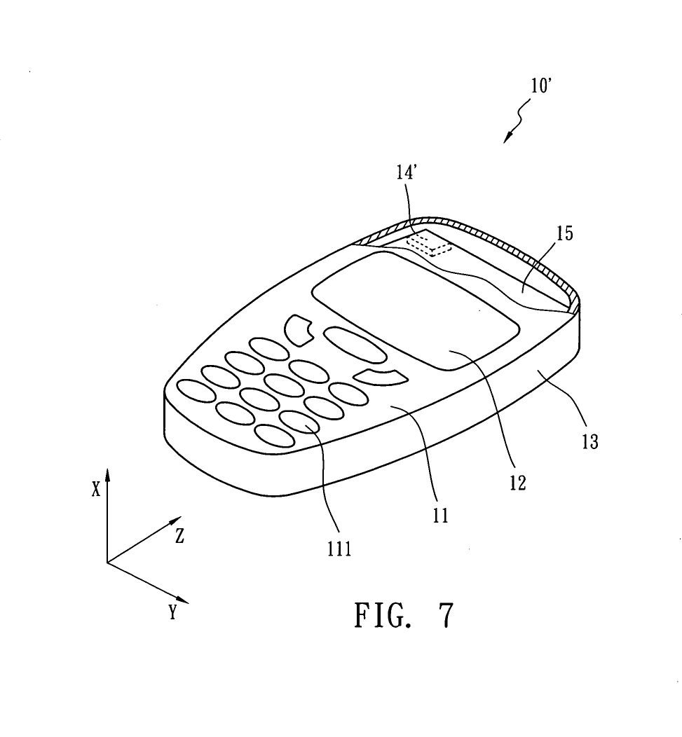

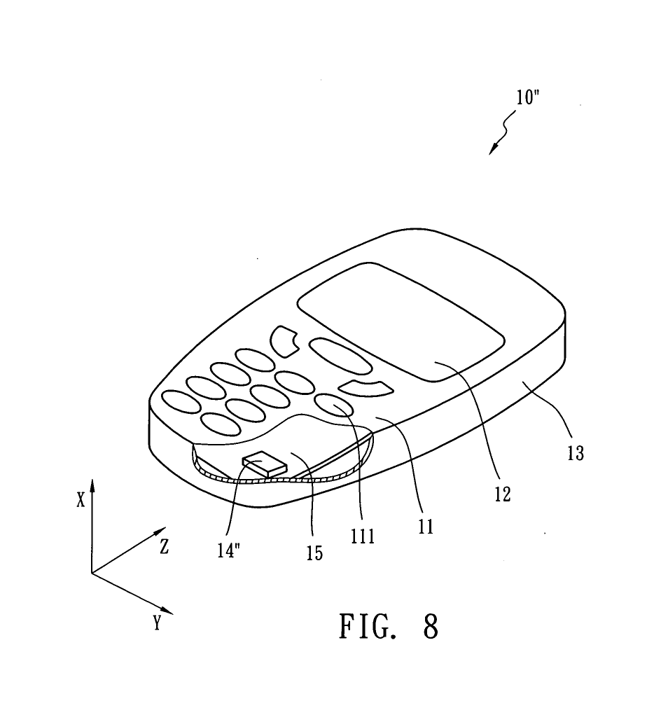

In addition to the above embodiments, the wireless apparatus 10 still has the global positioning function and a positioning signal receiving antenna 14′ can also be fixed on the circuit board 15 opposite to the back of the panel 11, as shown by a wireless apparatus 10′ in FIG. 7. Furthermore, a positioning signal receiving antenna 14″ can also be fixed in the fourth quadrant region of the circuit board 15, i.e., the bottom right region facing the graphic frame of the display screen, as shown by a wireless apparatus 10″ in FIG. 8. The wireless apparatus 10 can communicate with the ground-based wireless system via single, double or multi-channel communication.

The aforementioned descriptions of the present invention are intended to be illustrative only. Numerous alternative methods may be devised by persons skilled in the art without departing from the scope of the following claims.

What is claimed is:

1. A wireless apparatus capable of communicating with a global positioning system(GPS) and a ground-based wireless system, comprising:
at least one circuit board;
a panel with input keys;
a receiving antenna for receiving wireless signals from the ground-based wireless system;
a positioning signal receiving antenna fixed on the circuit board, having a feeding position of the positioning signal receiving antenna is located in the upper left region or the bottom right region relative to the center of the panel; and
a case connected to the panel.

2. The wireless apparatus capable of communicating with a GPS and a ground-based wireless system of claim 1, wherein the circuit board is fixed in the space formed by the panel and the case.

3. The wireless apparatus capable of communicating with a GPS and a ground-based wireless system of claim 1, further comprising an extension portion connected to the case, wherein the circuit board is fixed in the extension portion.

4. The wireless apparatus capable of communicating with GPS and ground-based wireless system of claim 3, wherein when the extension portion extends outward from the case, the fixed position of the positioning signal receiving antenna is located in the second quadrant region or the fourth quadrant region relative to the center of the panel.

5. The wireless apparatus capable of communicating with GPS and ground-based wireless system of claim 3, wherein the extension portion rotates or slides relative to the case and extends outward from the case.

6. The wireless apparatus capable of communicating with a GPS and a ground-based wireless system of claim 1, wherein the positioning signal receiving antenna is a chip antenna, a wire antenna, a reversed-L antenna, a reversed-F antenna or a plane antenna disposed on another small circuit board or an antenna obtained by modifying one of the aforesaid antennae.

7. The wireless apparatus capable of communicating with a GPS and a ground-based wireless system of claim 1, wherein no grounded circuit layer is laminated on the circuit board at the fixed position of the positioning signal receiving antenna.

8. The wireless apparatus capable of communicating with a GPS and a ground-based wireless system of claim 1, wherein a grounded circuit layer is laminated on the circuit board at the fixed position of the positioning signal receiving antenna.

9. The wireless apparatus capable of communicating with a GPS and a ground-based wireless system of claim 1, wherein the positioning signal receiving antenna is fixed on either of two surfaces of the circuit board.

10. The wireless apparatus capable of communicating with a GPS and a ground-based wireless system of claim 1, wherein the receiving antenna of the ground-based wireless system receives single channel or multi-channel wireless signals.
